(19) United States
(12) Patent Application Publication
(10) Pub. No.: US 2006/0125732 A1
(43) Pub. Date: Jun. 15, 2006

(54) Image display device

(75) Inventors: Fumio Haruna, Yokohama (JP); Junichi Satoh, Kamakura (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/298,582

(22) Filed: Dec. 12, 2005

(30) Foreign Application Priority Data
Dec. 13, 2004 (JP) 2004-359310

(51) Int. Cl. G09G 3/22

(52) U.S. Cl. 345/75.2

(57) ABSTRACT

For displaying an image on a display panel by luminance of a plurality of pixels having red, green and blue color elements based on a video signal, a correction circuit corrects the drive voltage by calculating a level for the correction of the drive voltage of the N pixels (N≧1) such that a change of luminance at the N pixels is at or below a human allowable limit. When the video signal has a constant horizontal level, the voltage generation circuit applies the drive voltage that shows a stepwise waveform of which the level is changed step-by-step from one end of a first lines, for example the scan lines, to the other end, and wherein a width of one stage of the stepwise pattern corresponds to a number from 3 to 99 times widths of the electron sources arranged in the first line's direction.

### TECHNICAL FIELD

The subject matter discussed herein relates to an image quality correction technology for a matrix-type image display device using electron emission elements such as thin-film electron sources (Field Emission Display, hereinafter, abbreviated as FED).

### BACKGROUND

An FED uses electron sources at respective intersections between a plurality of scan lines extending in a horizontal direction and a plurality of signal lines extending in a vertical directions. The electron sources are driven by scan voltage applied to the scan lines and signal voltage (corresponding to a picture signal) applied to the signal lines.

In such an FED, since a voltage drop is caused by wiring resistance of the scan lines, deterioration of image quality such as variation in luminance may occur. Japanese Patent Laid-open Publication No. 2002-229506 (JP2002-229506), for example, discloses a technique for correcting the deterioration of image quality

JP2002-229506 discloses a technology in which one scan line is divided into several blocks (4 blocks), and a level of voltage drop is calculated based on an image signal for each of the blocks, and image quality is corrected in correspondence with the level.

However, in the technology of JP2002-229506, image quality correction can not be made accurately because one scan line is divided into 4 blocks. Furthermore, when the number of divided blocks is not a multiple of 3, the difference of correction amount may occur in one pixel, which disrupts to color balance of the original in one pixel.

Hence a need exists for improving the technology for correcting image quality and thus improving image quality of a display image.

### SUMMARY

The teachings herein alleviate one or more the above noted problems by providing improved correction for display devices using thin film electron sources, for example, for a FED type display.

An image display device has scan lines and signal lines. A scan line control circuit applies scan voltage to the scan lines; and a signal line control circuit applies drive voltage corresponding to an inputted video signal to the signal lines so that electron sources disposed to intersections between the scan lines and the signal lines emit electrons according to potential difference between the scan voltage and the drive voltage. A correction circuit corrects the drive voltage by calculating a level for the correction of the drive voltage of the N pixels (N≧1) such that a change of luminance at the N pixels is at or below a human allowable limit.

Also disclosed is an image display device having electron sources at intersections of first and second lines and a voltage generation circuit to provide drive voltage according to the video signal. In this device, when the video signal has a constant horizontal level, the voltage generation circuit applies the drive voltage that exhibits a stepwise pattern at sources along a first line. The level of the pattern is changed step-by-step from one end of a first lines, for example the scan lines, to the other end, and a width of one stage of the stepwise pattern corresponds to a number from 3 to 99 times widths of the electron sources arranged in the first line's direction.

Additional advantages and novel features will be set forth in part in the description which follows, and in part will become apparent to those skilled in the art upon examination of the following and the accompanying drawing or may be learned by production or operation of the examples. The advantages of the patent teachings may be realized and attained by practice or use of the methodologies, instrumentalities and combinations particularly pointed out in the appended claims.

### BRIEF DESCRIPTION OF THE DRAWINGS

The drawing figures depict one or more implementations in accord with the present teachings, by way of example only, not by way of limitation. In figures, like reference numerals refer to the same or similar elements.

FIG. 1 is a block diagram showing an example of an image display device;

FIG. 2 is a block diagram showing a specific example of a signal processing circuit 10 shown in FIG. 1;

FIG. 3 is a view illustrating a characteristic of scan voltage according to the example;

FIGS. 4A and 4B form a block diagram showing an equivalent model of an electron source;

FIG. 5 is a block diagram showing a characteristic of applied voltage versus current of the electron source according to the example; and

FIGS. 6A and 6B form a block diagram showing a characteristic of correction data according to the example.

### DETAILED DESCRIPTION

In the following detailed description, numerous specific details are set forth by way of examples in order to provide a through understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

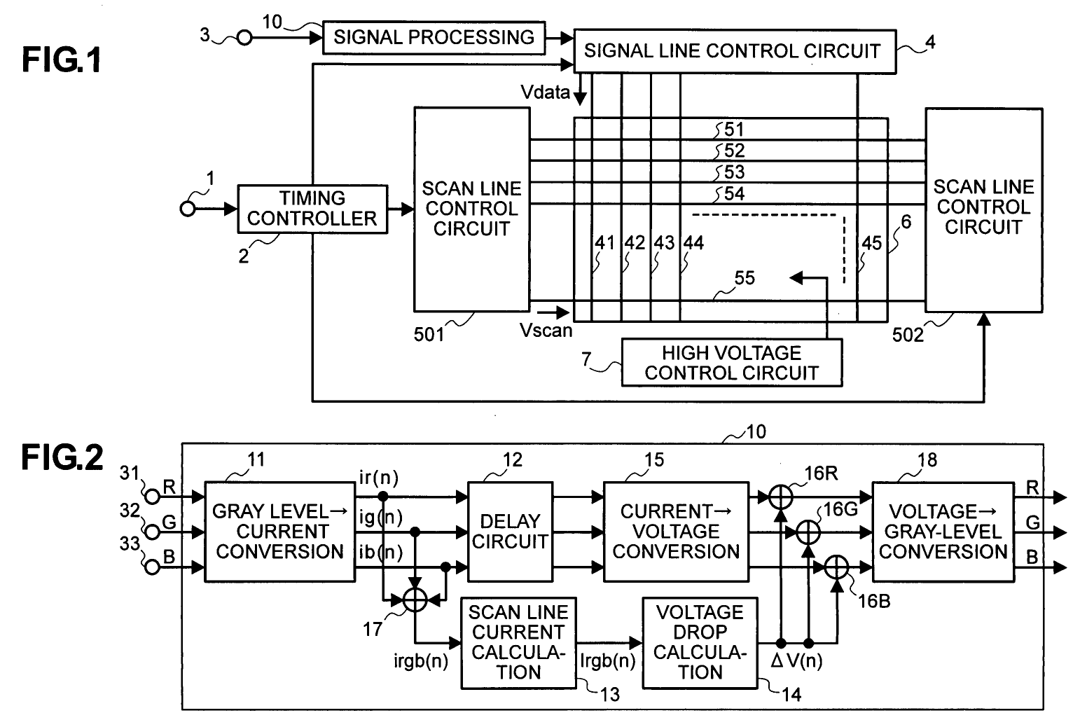

FIG. 1 shows an example of an electron emission element type, image display device. The example, uses an electron emission element type, image display device of a passive matrix drive type, which has a MIM (Metal-Insulator-Metal) type electron source as an electron source. However, the correction techniques can be similarly applied to displays using electron sources other than MIM, including SCE (Surface Conduction Electron Emitter) type, carbon nanotube type, BSD (Ballistic electron Surface-emitting Device) type, and Spindt type. Furthermore, hereinafter, description is made using a device having two scan-line control circuits 501 and 502 at two ends of the scan lines, as an example. However, it is natural that the teachings can also be applied to a device using only one of the scan-line control circuits and/or a different connection to the scan line(s).

A video signal is inputted into a video signal input terminal 3, and then supplied to a signal processing circuit 10. The signal processing circuit 10 includes a voltage-drop correction circuit to be described in detail with reference to FIG. 2. The correction circuit operates to compensate voltage drop caused by wiring resistance of scan lines 51 to 55. The operation is described in detail later.

A horizontal synchronization signal corresponding to the input video signal is inputted into a horizontal synchronization signal terminal 1, and then supplied to a timing controller 2. The timing controller 2 generates a timing pulse in synchronization with the horizontal synchronization signal and supplies the pulse into the scan line control circuits 501 and 502.

On the other hand, on a display panel 6, a plurality of scan lines 51 to 55 formed in a manner of extending in a horizontal direction on a screen (right and left direction on a paper) are disposed side by side in a vertical direction on the screen (up and down direction on the paper). Furthermore, a plurality of signal lines 41 to 45 formed in a manner of extending in a vertical direction on a screen (up and down direction on a paper) are disposed side by side in a horizontal direction on the screen (right and left direction on the paper). The scan lines 51 to 55 and the signal lines 41 to 45 are perpendicular to each other, and electron sources (electron emission elements) to be connected to respective scan lines and respective signal lines are disposed at respective intersections between the scan and signal levels. Thus, a plurality of electron sources are configured to be disposed in a matrix pattern. Those skilled in the art will understand that the horizontal-vertical configuration of the intersecting lines is exemplary only and that other orientations and/or other intersecting line arrangements may be used.

The scan-line control circuits 501 and 502 are connected to the right and left ends of the scan lines 51 to 55. The scan-line control circuits 501 and 502 supply scan voltage (Vscan) for selecting one or two of the scan lines 51 to 55 to the scan lines 51 to 55 in synchronization with timing pulses from the timing controller 2, respectively. Thus, the scan-line control circuits 501 and 502 sequentially apply scan voltage in the horizontal period to the scan lines 51 to 55, to thereby sequentially select one or two rows of electron sources in a horizontal period beginning at the top for vertical scan.

A signal line control circuit 4 as a signal voltage supply circuit is connected to upper ends of the signal lines 41 to 45. The signal line control circuit 4 generates a signal corresponding to each of the signal lines (electron source) based on the video signal supplied from the signal processing circuit 10, and supplies the signal to each of the signal lines.

When signal voltage (Vdata) is applied from the signal line control circuit 4 to respective electron sources connected to a scan line selected by the scan voltage, potential difference between the scan voltage and the signal voltage is given to respective electron sources. When the potential difference exceeds a predetermined threshold value, the electron sources emit electrons. When the potential difference is more than the threshold value, an emission level of the electrons from the electron sources is approximately in proportion to the potential difference. When the signal voltage is positive, the scan voltage is negative, and when the signal voltage is negative, the scan voltage is positive. Fluorescent materials and acceleration electrodes, which are not shown, are provided at positions opposed to respective electron sources. Spaces between the electron sources and the fluorescent materials are evacuated into a vacuum. Electrons emitted from the electron sources are accelerated by high voltage applied to the acceleration electrodes by a high-voltage control circuit 7, and move in the vacuum and collide with the fluorescent materials. This causes the fluorescent materials to emit light, and the light is radiated externally through a transparent glass substrate, which is not shown. Thus, a video image is formed on the FED.

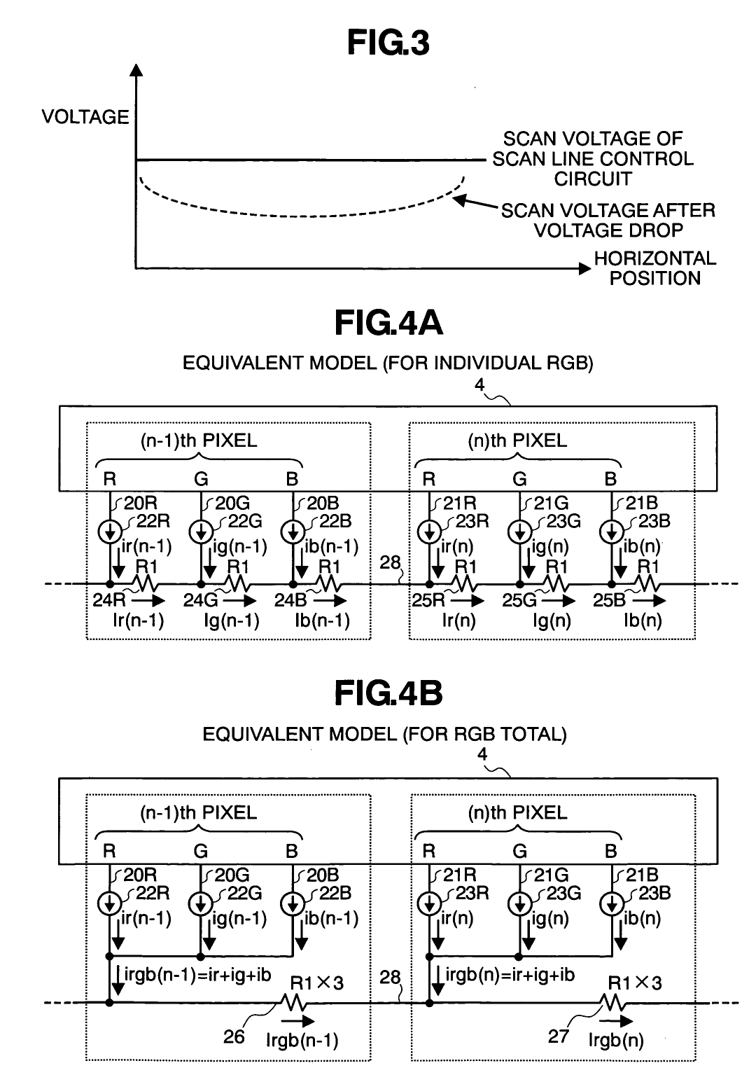

FIG. 3 shows a characteristic of change of scan voltage against a horizontal position of each electron source in the FED having such a configuration. A solid line in FIG. 3 shows scan voltage supplied from the scan line control circuits 501 and 502, and a dotted line shows a characteristic of a horizontal position of an electron source versus scan voltage. As shown in FIG. 3, voltage drop occurs in the scan voltage depending on the horizontal position of the electron source, and the voltage drop is maximized at the center.

The voltage drop occurs in the scan voltage, depending on the horizontal position, because of a voltage drop due to wiring resistance of the scan line. That is, when potential difference between scan voltage Vscan and signal voltage Vdata exceeds the predetermined threshold value, current flows from the signal line to the scan line, consequently voltage drop occurs due to the current and the wiring resistance of the scan line. As an amount of data displayed in one horizontal period is increased, for example, in the case of bar indication, an amount of the current into the scan line is increased and a level of the voltage drop is increased.

Hereinafter, a correction circuit for compensating such voltage drop according to this example is described in detail using FIG. 2. FIG. 2 is a block diagram for describing a specific example of a signal processing circuit 10 including the relevant correction circuit. The signal processing circuit 10 may be implemented by appropriate programming of a general purpose digital processor or by an appropriate design of discrete digital logic, e.g., in an ASIC. The correction circuit shown in FIG. 2 is configured to correct for the wiring resistance of scan lines. In FIG. 2, a gray level (contrast)-to-current conversion block 11 converts a digital gray-scale (contrast) signal of each of the R(Red) G(Green) B(Blue) video signals, which has been inputted into video signal input terminals 31 to 33, into a corresponding current. An addition operation block 17 totals current values of RGB.

Here, in FIGS. 4A and 4B, an equivalent model of the electron source is used for describing a purpose of totaling the current values of RGB. FIG. 4A shows a normal electron source model where the current values are not totaled. Signs 20R, 20G, 20B, 21R, 21G and 21B indicate signal lines. Each of the signal lines is connected to the signal line control circuit 4, and supplied with signal voltage corresponding to display video signal. Respective signal lines are connected with the electron sources.

As shown in FIG. 5, when voltage is applied to the electron sources, they generate currents. Accordingly, in FIGS. 4A and 4B, the electron sources are shown as current sources 22R, 22G, 22B, 23R, 23G and 23B. Respective electron sources are commonly connected to a scan line 28, and wiring resistances 24R, 24G, 24B, 25R, 25G and 25B exist between respective electron sources and the scan line 28. Current sources 22R, 23R correspond to color R, current sources 22G, 23G correspond to color G, and current sources 22B, 23B correspond to color B, stated another way, current sources 22R, 22G and 22B correspond to the (n−1)th pixel; and current sources 23R, 23G and 23B correspond to the (n)th pixel. Signal voltage Vdata corresponding to a video signal is applied from the signal line control circuit 4 to each of current sources 22R, 22G, 22B, 23R, 23G and 23B, and scan voltage is applied to the scan line 28. Each of current sources generates a signal line current ir(n−1), ig(n−1), ib(n−1), ir(n), ig(n) or ib(n) in correspondence with the signal voltage, which flows into the scan line 28.

Each of the signal line currents is divided in right and left directions as seen from a contact between the electron source and the scan line 28, and the ratio of the division obeys the Kirchhoff's theorem. That is, the ratio can be calculated from a wiring resistance ratio as seen from the contact between the electron source and the scan line 28. The signal line currents are totaled, thereby the scan line currents Ir(n−1), Ig(n−1), Ib(n−1), Ir(n), Ig(n) and Ib(n) are determined. The product of the scan line current multiplied by the scan line resistance is a voltage drop level.

For example, a voltage drop level in the (n)th pixel is Ir(n)×R1 in color R, Ig(n)×R1 in color G, and Ib(n)×R1 in color B; and the total voltage drop level in the (n)th pixel is Ir(n)×R1+Ig(n)×R1+Ib(n)×R1. It can be rearranged into (Ir(n)+Ig(n)+Ib(n))×R1. Furthermore, since the Ir(n), Ig(n) and Ib(n) adjacent to one another can be considered to have approximately equal current value, Ir(n)≅Ig(n)≅Ib(n) can be assumed, therefore the total voltage drop can be approximated by 3×Ir(n)×R1. From a different point of view, this indicates that a voltage drop level as seen in a pixel unit can be calculated by a scan line current (Ir(n)×(R1×3)) that is a current flowing through three scan line resistances R1. By using this idea, an electron source model in which current values are totaled as shown in FIG. 4B can be supposed.

In FIG. 4B, the signal lines and the current sources are the same as those in the model of FIG. 4A, and the contacts between the current sources and the scan line 28 are different from those in FIG. 4A. In FIG. 4B, contacts of three current sources for one pixel with the scan line 28 are common, and the wiring resistances 26, 27 are collected into one, R1×3. Since the contacts of three current sources with the scan line 28 are common, current flowing into the scan line 28, irgb(n), is ir(n)+ig(n)+ib(n). Respective signal line currents are divided in right and left directions as seen from the contacts between the electron sources and the scan line 28, and the ratio of the division obeys the Kirchhoff's theorem similarly as in FIG. 4A. The signal line currents are totaled, thereby the scan line currents Irgb(n−1) and Irgb(n) are determined. The product of the scan line current multiplied by the scan line resistance is the voltage drop level.

For example, a voltage drop level in the (n)th pixel is Irgb(n)×R1×3. Since the models of FIG. 4A and FIG. 4B are electrically equivalent, a correction circuit for calculating the voltage drop level can be designed based on FIG. 4B. When the electron sources are viewed in pixels as above, the total of the signal line currents of three current sources RGB, (ir(n)+ig(n)+ib(n)), can be used.

By using this idea, an addition operation block 17 in FIG. 2 totals the RGB signals which have been converted into current values in the gray-scale (contrast)-to-current conversion block 11. A scan line current calculation block 13 performs product-sum operation on total signal line current in one horizontal period, or total signal line current flowing from all signal lines 41 to 45 connected to one scan line, thereby calculates a scan line current Irgb(n) flowing into one scan line resistance R1. A voltage drop calculation block 14 calculates a voltage drop level ΔV(n) by multiplying the scan line current Irgb(n) calculated in the scan line current calculation block 13 by the scan line resistance R1. The voltage drop calculation block 14 calculates a level for the correction of the drive voltage of the N pixels (N≧1) such that a change of luminance at the N pixels is at or below a human allowable limit.

On the other hand, respective RGB current values in the gray scale (contrast)-to-current conversion block 11 are sent to the addition operation block 17 and concurrently inputted into a delay circuit 12. The delay circuit 12, which comprises a FIFO memory, stores respective RGB current values for a period corresponding to one horizontal period, and outputs the stored current values during a next horizontal period, thereby delays respective RGB current values only by the period corresponding to one horizontal period.

The reason for this is as follows. That is, when the scan line current calculation block 13 calculates a total signal line current in one horizontal period, results of calculation of the scan line current calculation block 13 are given one horizontal period after. Therefore, respective RGB current values are also delayed in order to synchronize with the calculation results of the scan line current calculation block 13. A current-to-voltage conversion block 15 converts respective RGB current values, which have been delayed by the period corresponding to one horizontal period, into voltage values, and addition operation blocks 16R, 16G and 16B add a same voltage drop level ΔV(n) to respective RGB voltage values. The voltage drop level ΔV(n) is added to the values corresponding to the video signal, thereby voltage drop can be corrected. Finally, a voltage-to-gray scale conversion block 18 reconverts respective RGB voltage values to which the voltage drop level has been added in the voltage-to-gray scale to digital gray-scale signals.

As described hereinbefore, the signal lines of RGB adjacent to one another, or three signal lines corresponding to one pixel are virtually totaled into a single signal line, and the voltage drop level is calculated in a unit of the totaled signal lines. Accordingly, the RGB signals need not be converted into a serial signal and can be processed as they are parallel, consequently can be operated by using a typical logic IC. That is, generally, when parallel signals of RGB are converted into a serial signal, the serial signal needs to be generated with a clock signal three times as fast as that in the original parallel signals. Therefore, according to the example, a construction for converting parallel signals into a serial signal is not required, and the correction level can be calculated in a simple construction.

When signals are virtually totaled into a single signal line value in a unit rather than the unit of RGB adjacent to one another, a portion where correction data are significantly different for one pixel, which disrupts color balance of the original image at the portion. Therefore, every RGB adjacent to one another virtually totals into a single signal line value. For example, plural units of RGB adjacent to one another can be collected into a single signal line to calculate the correction level.

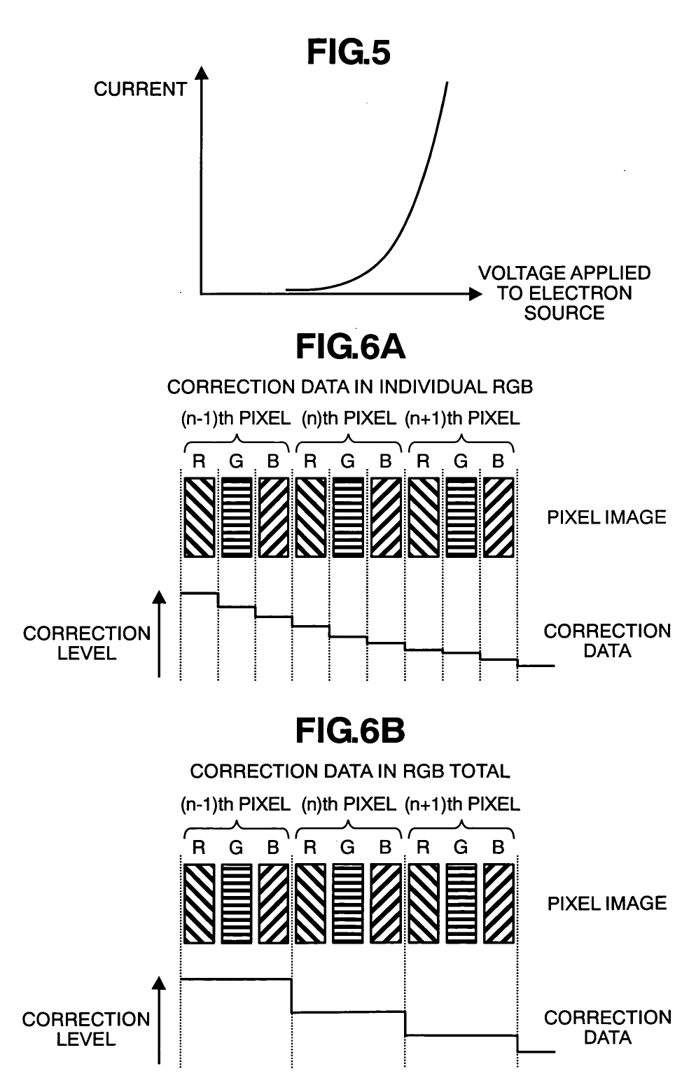

Next, a specific example of the voltage correction level in the example is shown in FIGS. 6A and 6B. First, FIG. 6A is a view of an example, wherein a voltage drop level is calculated for each of RGB to obtain the correction levels, and in this case the correction levels are different for each of RGB. On the other hand, FIG. 6B is a view of the example wherein the voltage drop level is calculated in a unit of one pixel (RGB total) to obtain the correction levels, and in this case the correction levels are constant in one pixel of RGB. Even if the correction levels are constant in pixels as shown in FIG. 6B, color does not change after the correction. This is because even if the voltage drop levels are calculated for each of RGB as shown in FIG. 6A, the correction levels for each of RGB are changed small, consequently a gentle slope is formed.

However, when a unit of RGB total comprises two pixels or more, change of correction levels between adjacent units is gradually increased, therefore change of luminance or color is considered to be visible at the portion where the correction levels is changed. Thus, a unit of RGB total at the visible limit is calculated below.

First, when resolution of a panel is according to VGA, the number of pixels is 640, and the number of signal lines is 640×3=1920. Portions where a voltage drop level is maximized are right and left ends as shown in FIG. 3, and in the case of the left end, the level is a voltage drop level between R and G of the first pixel. Here, difference of luminance where change of luminance can be visually perceived by a human is generally regarded as 1% or more. When luminance is substituted by applied voltage, since applied voltage at white display is 3 Vpp as a maximum applied voltage, it is assumed that when voltage difference is 30 mVpp or more, which is 1% of the above applied voltage, the difference of luminance is visible. Thus, assuming that the voltage drop level between R and G of the first pixel is ΔVm, and the number of pixels of RGB total is N, the maximum value of N that satisfy,
ΔVm×3×N<30mVpp
can be approximated at the visible limit. Thus, N′=30 mVpp/(ΔVm×3) is calculated, and then N is obtained by truncating N′.

First, in order to obtain ΔVm, a scan line current Ir(1) between R and G of the first pixel needs to be obtained. Each signal line current (such as ir(n) in FIG. 4) can be calculated based on the Kirchhoff's theorem, and when the nth signal line current is assumed to be i(n), Ir(1) is expressed by;
Ir(1)=Σ((1919−n)/1919×i(n)) (n:1 to 1919).

Here, when the video signal is assumed to indicate all white display, and i(n) at that time is assumed to be 100 μA as a value in the case of typical white display, Ir(1)=96 mA is given. Here, when resistance of a scan line between R and G of the first pixel is assumed to be R1, ΔVm=R1×Ir(1) is given, and when R1 is assumed to be 9 mΩ as a typical value, ΔVm=9 mΩ×96 mA=864 μV is given, and N′=30 mVpp/(864 μV×3)=11.57 is truncated, as a result N=11 is obtained.

Thus, if the number of pixels of RGB total is not more than 11, change of luminance is not visible. N=11 corresponds to 33 of the electron sources. When the video signal has a constant horizontal level, the voltage shows a pattern at electron sources along a signal line, wherein the level is changed step-by-step from one end of the scan lines to the other end, and wherein a width of one stage of the stepwise pattern corresponds to a number from 3 to 99 times widths of the electron sources arranged in the first direction.

As above, when data values for several signal lines are virtually totaled into a value for single signal line to calculate the voltage drop level, an error to true correction data is increased with increase in number of pixels of RGB total. Therefore, as calculated in the above, the number of pixels of RGB total is desirably within a range where change of luminance is not visible.

The above calculation method is an example for obtaining the number of pixels of RGB total wherein change of luminance or color is not visible. Accordingly, since the voltage drop level depends on resolution of a panel and a scan-line-voltage supply circuit, other values can be used depending on those. Moreover, while the voltage drop level between R and G at the left end, at which the level is maximized, was used as a voltage drop level, if a voltage drop level is in a region having a large voltage-drop-level range, it can be used. Luminance change of 1% of the maximum applied drive voltage as the visible limit of human perception (human detection limit) was used in the example. However, a somewhat higher value of luminance change corresponding to the visually allowable or acceptable limit for the change (human allowable limit) may be used such as luminance change of around 3% of the maximum applied drive voltage. If 3% is used, the above described N is equal to 33. N=33 corresponds to 99 of the electron sources.

When the detection limit is considered in this way, data values for signal lines to be virtually totaled into a value for a single signal line may not necessarily be every RGB adjacent to one another.

When the above correction is made, if a video signal having a constant horizontal level is inputted as an input video signal, drive voltage from a signal control circuit shows a stepwise output waveform as shown in FIG. 6B. At that time, in the case of a configuration where scan line control circuits are disposed at two ends of scan lines as in the example, since voltage drop is maximized at the center of the scan lines, output waveform from the signal control circuit is a stepwise waveform where the output is maximized at the center. On the contrary, in the case of a configuration where the scan line control circuit is provided at one ends of scan lines, since voltage drop is maximized at the other ends where the scan line control circuit is not provided, the output waveform from the signal control circuit is a stepwise waveform where the output is gradually increased from a side of the scan line control circuit and maximized at a side of the other end.

According to the above configuration, a technology that is preferable for calculating a correction level in a simple construction compared with the conventional construction, and thus improving image quality can be provided.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. An image display device for displaying an image by luminance of a plurality of pixels based on a video signal, each pixel having red, green and blue color elements, comprising:
a plurality of scan lines,
a scan line control circuit, coupled to the plurality of scan lines, that applies scan voltage to the scan lines;
a plurality of signal lines;
a signal line control circuit, coupled to the plurality of signal lines, that applies drive voltage corresponding to the video signal to the signal lines;
electron sources, coupled to intersections between the plurality of scan lines and the plurality of signal lines, that emit electrons according to potential difference between the scan voltage and the drive voltage so that the plurality of pixels are illuminated; and
a correction circuit that corrects the drive voltage;
wherein the correction circuit calculates a level for the correction of the drive voltage of N of the pixels (N≧1) such that a change of luminance at the N pixels is at or below a human allowable limit.

2. The image display device according to claim 1, wherein a maximum value of the N is determined based on the human allowable limit being 3% of maximum applied-voltage applied from the signal line control circuit.

3. The image display device according to claim 1, wherein a range of a value of the N is 1≦N≦33.

4. The image display device according to claim 1, wherein a maximum value of the N is determined based on 1% of maximum applied-voltage applied from the signal line control circuit.

5. The image display device according to claim 1, wherein a range of a value of the N is 1≦N≦11.

6. A drive circuit for displaying an image on a display panel by luminance of a plurality of pixels based on a video signal, comprising:
a scan line control circuit, coupled to a plurality of scan lines of the display panel, that applies scan voltage to the scan lines;
a signal line control circuit, coupled to a plurality of signal lines of the display panel, that applies drive voltage corresponding to the video signal to the signal lines;
a correction circuit that corrects the drive voltage;
wherein the correction circuit calculates a level for the correction of the drive voltage of N of the pixels (N≧1) such that a change of luminance at the N pixels is at or below a human allowable limit.

7. The drive circuit according to claim 6, wherein a maximum value of the N is determined based on the human allowable limit being 3% of maximum applied-voltage applied from the signal line control circuit.

8. The drive circuit according to claim 6, wherein a range of a value of the N is 1≦N≦33.

9. The drive circuit according to claim 6, wherein a maximum value of the N is determined based on 1% of maximum applied-voltage applied from the signal line control circuit.

10. The image display device according to claim 6, wherein a range of a value of the N is 1≦N≦11.

11. An image display method for displaying an image on a display panel by luminance of a plurality of pixels based on a video signal, each pixel having red, green and blue color elements, comprising the steps of:
applying scan voltage to a plurality of scan lines of the display panel and drive voltage corresponding to the video signal to a plurality of signal lines of the display panel to illuminate the plurality of pixels; and
correcting the drive voltage based on the result of calculating a level for the correction of the drive voltage of N of the pixels (N≧1) such that a change of luminance at the N pixels is at or below an human allowable limit.

12. The image display method according to claim 11, wherein a maximum value of the N is determined based on the human change limit being 3% of maximum applied-voltage applied from the signal line control circuit.

13. The image display method according to claim 11, wherein a range of a value of the N is 1≦N≦33.

14. The image display method according to claim 11, wherein a maximum value of the N is determined based on 1% of maximum applied-voltage applied from the signal line control circuit.

15. The image display method according to claim 11, wherein a range of a value of the N is 1≦N≦11.

16. An image display device for displaying an image on a display panel based on a video signal, comprising:
electron sources disposed at intersections between a plurality of first lines extended in a first direction of the display panel and a plurality of second lines of the display panel extending perpendicular to the first direction; and
a voltage generation circuit that generates drive voltage according to the video signal and applies the drive voltage to the electron sources via the second lines,
wherein when the video signal has a constant horizontal level, the voltage shows a pattern at electron sources along a first line, wherein the level is changed step-by-step from one end of the first line to the other end, and wherein a width of one stage of the stepwise pattern corresponds to a number from 3 to 99 times widths of the electron sources arranged in the first direction.

17. The image display device according to claim 16, wherein the stepwise waveform is maximized at centers of the first lines.

18. The image display device according to claim 16, wherein the stepwise waveform is minimized at one ends of the first lines, and maximized at the other ends.
